(19) United States
(12) Patent Application Publication
(10) Pub. No.: US 2013/0314373 A1
(43) Pub. Date: Nov. 28, 2013

(54) TOUCH DETECTING DEVICE USING SENSOR PAD SCRAMBLE

(71) Applicant: Crucialtec Co., Ltd., Chungcheongnam-do (KR)

(72) Inventors: Jae Heung KIM, Gyeonggi-do (KR); Young Jin OH, Gyeonggi-do (KR)

(73) Assignee: CRUCIALTEC CO., LTD., Chungcheongnam-do (KR)

(21) Appl. No.: 13/902,786

(22) Filed: May 25, 2013

(30) Foreign Application Priority Data
May 25, 2012 (KR) 10-2012-0055842

(51) Int. Cl. G06F 3/044

(52) U.S. Cl. CPC G06F 3/044
USPC 345/174; 178/18.06

(57) ABSTRACT

A capacitive type touch detecting device includes a first sensor pattern sub-group including a plurality of sensor pads, a second sensor pattern sub-group adjacent to the first sensor pattern sub-group in a second axis direction, a third sensor pattern sub-group adjacent to the first sensor pattern sub-group in the first axis direction, and a fourth sensor pattern sub-group adjacent to the second sensor pattern sub-group in the first axis direction. The sensor pads belonging to the first and third sensor pattern sub-groups are electrically connected, and the sensor pads belonging to the second and fourth sensor pattern sub-groups are electrically connected. A sequence in which the sensor pads belonging to the first and third sensor pattern sub-groups are connected is different from that in which the sensor pads belonging to the second and fourth sensor pattern sub-groups are connected.

### CROSS-REFERENCE TO RELATED APPLICATION

This application claims priority to Korean Patent Application No. 2012-55842, filed on May 25, 2012, and all the benefits accruing therefrom under 35 U.S.C. §119, the content of which in its entirety is herein incorporated by reference.

### BACKGROUND

1. Field of the Invention

The disclosure relates to a capacitive type touch detecting device, and more particularly, to a capacitive type touch detecting device that includes one or more sensor pattern sub-groups in which a plurality of sensor pads are disposed.

2. Discussion of Related Art

Touch detecting devices are devices that are touched with a finger or another touching tool based on information displayed by an image display device so as to input an instruction of a user. To this end, the touch detecting device is provided on a front face of the image display device, and converts a touch position directly touched with the finger or the other touching tool into an electrical signal. As a result, an instruction selected at the touch position is received as an input signal.

As types in which the touch detecting device is realized, a resistive type, a photosensitive type, and a capacitive type are known. The capacitive type touch detecting device detects a change in capacitance which is formed by a conductive detection pattern along with another surrounding detection pattern or a ground electrode when a finger or an object is touched, and converts a touch position into an electrical signal.

The conventional capacitive type touch detecting device is configured so that sensor pads are formed on one surface of a substrate and that the sensor pads should be connected to touch integrated circuits (IC) via interconnections in a one-to-one relation. As such, when the number of sensor pads is great, the capacitive type touch detecting device has problems that the restrictions of space are imposed when it is expanded to a wide area.

FIG. 1 shows a plane configuration relating to another example of a conventional capacitive type touch detecting device.

The capacitive type touch detecting device shown in FIG. 1 includes sensor pads 5 formed on a single layer. Since wires are connected to respective sensor pads 5, this capacitive type touch detecting device is increased in size, and has a problem that the number of wires is increased in proportion to the number of sensor pads 5.

### SUMMARY

The disclosure provides a capacitive type touch detecting device that includes one or more sensor pattern sub-groups in which a plurality of sensor pads are disposed in a first axis direction.

In an aspect, there is provided a capacitive type touch detecting device. The capacitive type touch detecting device includes a first sensor pattern sub-group including the first sensor pads disposed in a first axis direction, a second sensor pattern sub-group adjacent to the first sensor pattern sub-group in a second axis direction, the second sensor pattern sub-group including second sensor pads disposed in the first axis direction, a third sensor pattern sub-group adjacent to the first sensor pattern sub-group in the first axis direction, the third sensor pattern sub-group including third sensor pads disposed in the first axis direction, the third sensor pads electrically connected to the first sensor pads in a first sequence, and a fourth sensor pattern sub-group adjacent to the second sensor pattern sub-group in the first axis direction, the fourth sensor pattern sub-group including fourth sensor pads disposed in the first axis direction, the fourth sensor pads electrically connected to the second sensor pads in a second sequence, the second sequence being different from the first sequence.

In an example, the electrically connected sensor pads may be connected by signal wires formed of the same material as the sensor pads.

Further, the signal wires may connect the sensor pads within a display region of a touch detecting device.

The first and third sensor pads may be electrically connected by first signal wires, and the second and fourth sensor pads are electrically connected by second signal wires, and the first and second signal wires may be disposed on the same plane without crossing one another.

Also, the sensor pads may be formed of a transparent conductive material.

The capacitive type touch detecting device may further include a touch detector that detects a touch based on a variation in voltage between when the touch of the sensor pad occurs and when the touch of the sensor pad does not occur.

In addition, the touch detector may compare a pattern in which the voltage variation when the touch occurs at the plurality of sensor pads is generated with a preset pattern, and decide to which one of the first to fourth sensor pattern sub-groups the sensor pad that is touched belongs.

According to the aspect as described above, a capacitive type touch detecting device is formed in a single layer, so that production cost can be reduced, and a manufacturing process can be simplified. Since fewer wires than in a structure in which the wires are connected to respective sensor pads are required, a space for arranging the wires can be minimized

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 shows a plane configuration relating to a conventional capacitive type touch detecting device;

FIG. 2A shows a configuration of a capacitive type touch detecting device according to an aspect;

FIG. 2B shows a capacitive type touch detecting device installed on a display device according to the aspect;

FIG. 2C shows an equivalent circuit for detecting a touch when the touch occurs;

FIG. 3 illustrates a capacitive type touch detecting device according to another aspect;

FIG. 4 illustrates a capacitive type touch detecting device according to yet another aspect;

FIG. 5 illustrates a capacitive type touch detecting device according to yet another aspect;

FIG. 6 shows a configuration of a capacitive type touch detecting device according to the aspect; and

FIG. 7 is a flow chart showing a method of detecting a touch according to the aspect.

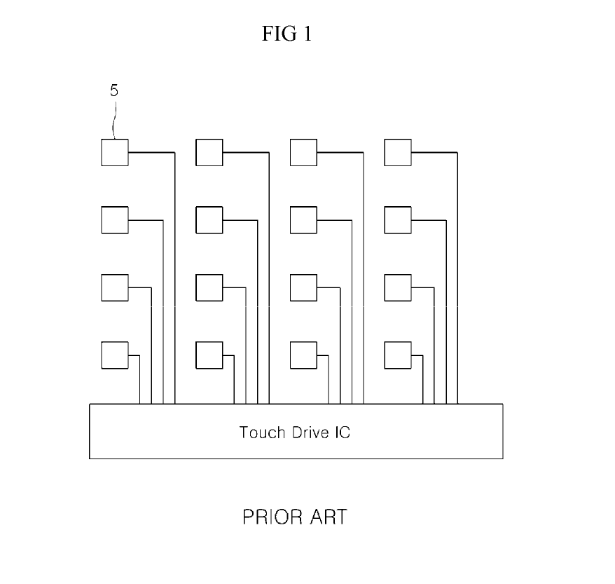

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Throughout the specification, when a certain portion “includes” a certain component, this indicates that the other components may be further included rather than excluded unless otherwise noted. The terms “unit,” “-or/-er,” and “module” used herein indicate a unit for processing at least one function or operation, which may be implemented by hardware, software or a combination thereof.

Throughout the specification, when a certain portion is “connected” or “coupled” to another portion, this may not only be “directly connected” or “coupled” to the other portion, but may also be “indirectly connected” or “coupled” to the other portion with another component interposed therebetween.

In the following description, the same or similar elements are denoted by the same reference numerals, and an unnecessary repeated description thereof and a description of known technologies will be omitted.

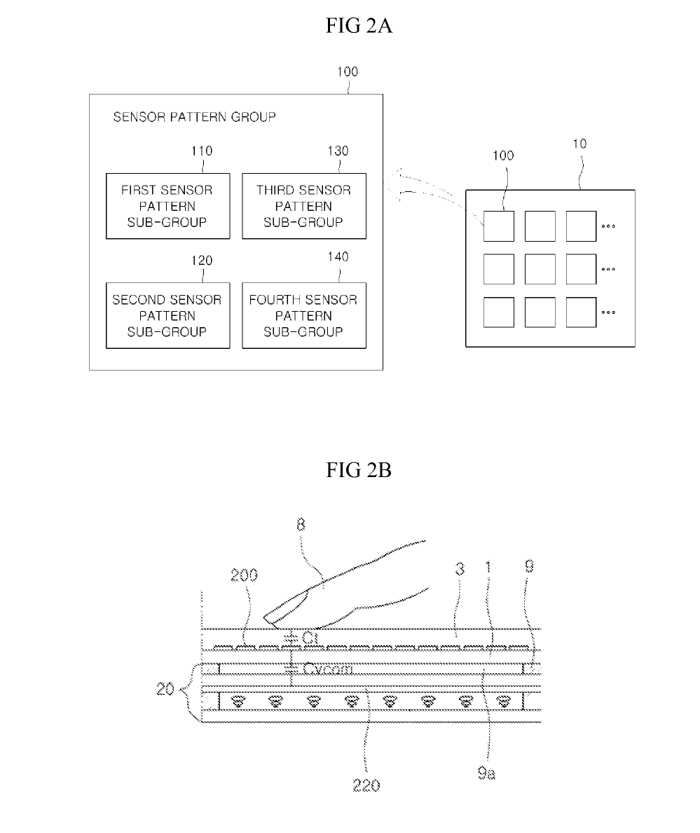

FIG. 2A shows a configuration of a capacitive type touch detecting device according to an aspect of this disclosure.

Referring to FIG. 2A, a capacitive type touch detecting device 10 according to a first aspect may include one or more sensor pattern groups 100 disposed in a row and/or column direction. Each sensor pattern group 100 may include sensor pattern sub-groups in which a plurality of sensor pads are disposed in a first axis direction.

FIG. 2B shows a capacitive type touch detecting device formed on a display device.

Referring to FIG. 2B, a touch detecting device is disposed on a display device 20. Thus, sensor pads 200 are disposed on an upper surface of a substrate 1, and a protective panel 3 for protecting the sensor pads 200 may be attached above the substrate 1. The touch detecting device is adhered to the display device 20 via an adhesive member 9, and an air gap 9a may be formed between the touch detecting device and the display device 20.

Each sensor pad 200 is an electrode that is patterned on the substrate in order to detect touch input. Touch capacitance Ct may be formed between the sensor pad 200 and a touch input tool such as a finger or a conductor. When a touch occurs, the touch capacitance Ct is formed between the sensor pad 200 and the touch input tool.

In FIG. 2B, when the touch occurs, the capacitance such as Ct is formed between the finger 8 and the sensor pad 200, and the capacitance such as Cvcom is formed between the sensor pad 200 and a common electrode 220. Unknown parasitic capacitance Cp is formed on the sensor pad 200.

FIG. 2C shows an equivalent circuit for detecting a touch when the touch occurs. Referring to FIGS. 2B and 2C, when the finger touches the sensor pad 200, Cvcom, Cdrv, Cp, and Ct are generated, and the capacitive type touch detecting device detects a variation of Ct, thereby recognizing the touch.

When the touch capacitance Ct is substituted into Equation 1 below, an area touched by a touch input tool may be measured.

$${C}_{t} = ɛ \frac{S 2}{D 2} \qquad Equation 1$$

In Equation 1, ε is the permittivity, and may be obtained from a medium between the sensor pad 200 and the finger. If tempered glass is attached to the upper surface of the substrate, the permittivity c can be derived from a value of relative permittivity of the tempered glass multiplied by permittivity of vacuum. The numerator S2 corresponds to an area in which the sensor pad 200 faces the finger. For example, if the finger covers the entire sensor pad 200, S2 corresponds to an area of the sensor pad 200. If the finger covers a part of the sensor pad 200, S2 is reduced by an area in which the sensor pad 200 does not face the finger. The denominator D2 is a distance between the sensor pad 200 and the finger, and corresponds to a thickness of the tempered glass or a protective panel that is placed on the upper surface of the substrate.

According to Equation 1, Ct is proportional to the area in which the sensor pad 200 faces the finger. As such, a touch occupation rate of the finger relative to the sensor pad 200 may be calculated from Ct. Thus, it is possible to check whether or not a touch signal is detected based on Ct, and to find the area touched by the finger if Ct is substituted into Equation 1 above. Referring to FIG. 2A again, each sensor pattern group 100 of the capacitive type touch detecting device 10 may include the sensor pattern sub-groups in which the plurality of sensor pads are disposed in the first axis direction.

The sensor pattern group 100 may include a first sensor pattern sub-group 110, a second sensor pattern sub-group 120 adjacent to the first sensor pattern sub-group 110 in a second axis direction, a third sensor pattern sub-group 130 adjacent to the first sensor pattern sub-group 110 in the first axis direction, and a fourth sensor pattern sub-group 140 adjacent to the second sensor pattern sub-group 120 in the first axis direction, all of which include a plurality of sensor pads.

Here, the sensor pads belonging to the first sensor pattern sub-group 110 may be electrically connected to those belonging to the third sensor pattern sub-group 130. The sensor pads belonging to the second sensor pattern sub-group 120 may be electrically connected to those belonging to the fourth sensor pattern sub-group 140. Further, a sequence in which the sensor pads belonging to the first and third sensor pattern sub-groups 110 and 130 are connected may be different from that in which the sensor pads belonging to the second and fourth sensor pattern sub-groups 120 and 140 are connected.

Further, each sensor pad may be connected to one of the plurality of sensor pads of the other sensor pattern sub-group rather than to the plurality of sensor pads of the other sensor pattern sub-group. The sensor pads included in the same sensor pattern sub-group are not repetitively connected to one another.

The electrically connected sensor pads may be connected by sensor signal wires formed of the same material as the sensor pad. Further, the sensor signal wires may connect the sensor pads within a display region of the touch detecting device.

For example, the sensor pads connected between the first and third sensor pattern sub-groups 110 and 130 may be connected by first signal wires (not shown), and the sensor pads connected between the second and fourth sensor pattern sub-groups 120 and 140 may be connected by second signal wires (not shown). Here, the first and second signal wires are disposed on the same plane without crossing one another.

Further, the sensor pads 200 may be connected to a touch detector (not shown) to be described below by the first and second signal wires.

Here, the first and second signal wires may be formed of the same material as the sensor pads 200. For example, if the sensor pads 200 are formed of a transparent conductive material such as indium tin oxide (ITO), the first and second signal wires may also be formed of a transparent conductive material.

The capacitive type touch detecting device may further include a touch detector (not shown).

The touch detector may detect a touch based on a variation or difference in voltage between when a touch of the sensor pad 200 occurs and when a touch of the sensor pad 200 does not occur. Here, the touch detector may be connected to each sensor pad by the first and second signal wires.

Further, the touch detector may calculate a touch area of each sensor pad based on the voltage variation of each sensor pad, and then touch coordinates on a touchscreen.

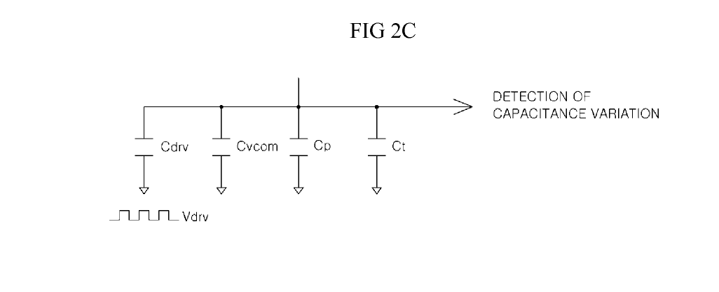

Here, a detection region for detecting the touch when the touch occurs may include a combined area of the two sensor pads 200. For example, an area in which the sensor pad belonging to the first sensor pattern sub-group 110 and the sensor pad belonging to the second sensor pattern sub-group 120 adjacent to the first sensor pattern sub-group 110 in the second axis direction are included may be the detection region in which the touch can be detected when the touch occurs. A description of the detection region will be made below in conjunction with FIG. 3.

The touch detector may compare a pattern in which the voltage variation occurs when the touch occurs in the plurality of sensor pads with a preset pattern, and determine to which sensor pattern sub-group(s) among the first to fourth sensor pattern sub-groups the sensor pads that are touched belong The preset pattern may be a pattern obtained when the sensor pads connected in each column in different sequences are touched in rows at the same time.

In this case, since one of the sensor pads of the first sensor pattern sub-group 110 and one of the sensor pads of the third sensor pattern sub-group 130 are electrically connected, and since one of the sensor pads of the second sensor pattern sub-group 120 and one of the sensor pads of the fourth sensor pattern sub-group 140 are electrically connected, it is difficult to calculate the touch coordinates based on the voltage variation of each sensor pad.

Thus, in one example of the sensor pattern group, since the sequence in which the sensor pads belonging to the first and third sensor pattern sub-groups 110 and 130 are electrically connected is different from that in which the sensor pads belonging to the second and fourth sensor pattern sub-groups 120 and 140 are electrically connected, when the detection region in which the touch is detected includes the sensor pad of the first sensor pattern sub-group 110 and the sensor pad of the second sensor pattern sub-group 120, the touch of each sensor pad may be detected distinctively. This will be described below with reference to FIG. 3.

In another example, since the capacitive type touch detecting device is formed in a single layer, it is possible to reduce costs required to form a layer of expensive ITO. Since the sensor pads and the signal wires are formed on the same plane, a manufacturing process can also be simplified.

Further, in the capacitive type touch detecting device, a plurality of sensor pads included in the specified sensor pattern sub-group are connected to a plurality of sensor pads included in the sensor pattern sub-group adjacent to the specified sensor pattern sub-group in the first axis direction. As such, in comparison with the related art in which a signal wire for one-to-one connection with a touch detector should be formed on each sensor pad, the capacitive type touch detecting device requires a relatively smaller number of signal wires, and thus can reduce a space for the signal wires.

FIG. 3 illustrates a capacitive type touch detecting device according to another aspect.

A capacitive type touch detecting device according to another aspect may include sensor pattern sub-groups in which a plurality of sensor pads 200 are disposed in a first axis direction.

The sensor pads 200 may output a signal according to a touched state in response to an alternating current (AC) voltage in a floating state after electric charges are charged. For example, the sensor pads 200 may output a variation between a quantity of touched electric charge and a quantity of untouched electric charge according to a touched state of a touch input tool in response to AC voltage alternating at predetermined frequencies. A touch detector (not shown) to be described below may measure a variation in voltage using the variation between the quantity of touched electric charge and the quantity of untouched electric charge at each sensor pad 200, and detect a touch based on the measured voltage variation.

Thus, the capacitive type touch detecting device may measure a touch area of each sensor pad 200 based on the voltage variation. Here, the plurality of sensor pads 200 are disposed in the front of a touchscreen in an independent polygonal shape. Further, when the touch area of each sensor pad is calculated, it is possible to calculate touch coordinates on the touchscreen.

The sensor pads 200 may be formed of a transparent conductive material. For example, the sensor pads 200 may be formed of indium tin oxide (ITO), antimony tin oxide (ATO), carbon nanotubes (CNTs), or indium zinc oxide (IZO), and are not limited thereto. The sensor pads 200 may be formed of a metal.

A sensor pattern group 100 may include a first sensor pattern sub-group 110, a second sensor pattern sub-group 120, a third sensor pattern sub-group 130, and a fourth sensor pattern sub-group 140. In detail, the sensor pattern group 100 may include the first sensor pattern sub-group 110, the second sensor pattern sub-group 120 adjacent to the first sensor pattern sub-group 110 in a second axis direction, the third sensor pattern sub-group 130 adjacent to the first sensor pattern sub-group 110 in the first axis direction, and the fourth sensor pattern sub-group 140 adjacent to the second sensor pattern sub-group 120 in the first axis direction. That is, as shown in FIG. 3, the sensor pattern sub-groups 110, 120, 130, and 140 of the sensor pattern group 100 may each include four sensor pads 200.

Here, the sensor pads belonging to the first sensor pattern sub-group 110 may be electrically connected to the sensor pads belonging to the third sensor pattern sub-group 130.

The sensor pads belonging to the second sensor pattern sub-group 120 may be electrically connected to the sensor pads belonging to the fourth sensor pattern sub-group 140. Further, a sequence in which the sensor pads belonging to the first and third sensor pattern sub-groups 110 and 130 are connected may be different from that in which the sensor pads belonging to the second and fourth sensor pattern sub-groups 120 and 140 are connected.

Here, the sensor pads connected between the first and second sensor pattern sub-groups 110 and 130 may be connected by first signal wires a1, a2, a3, and a4. Further, the sensor pads connected between the second and fourth sensor pattern sub-groups 120 and 140 may be connected by second signal wires b1, b2, b3, and b4. In this case, the first and second signal wires are disposed on the same plane without crossing.

Hereinafter, for convenience of description, it is described that the sensor pads disposed in the first axis direction are located at first to fourth columns according to a sequence disposed in each sub-group.

Likewise, if the sensor pads are disposed in the second axis direction, it can be described for convenience of description that the sensor pads are located at first to fourth rows according to a sequence disposed in each sub-group.

In the specification and the claims, when it is described that first sensor pads of a first sensor pattern sub-group are connected to third sensor pads of a third sensor pattern sub-group in a first sequence, a second sensor pads of a second sensor pattern sub-group are connected to fourth sensor pads of a fourth sensor pattern sub-group in a second sequence, and the first sequences is different from the second sequence, it means that the connecting sequences between the sensor pads of the sensor pattern sub-groups connected to each other are different in terms of the sequence of the column or row of the sensor pads, depending on the disposition of the sensor pads.

For example, the sensor pad located at the first column of the first sensor pattern sub-group 110 and the sensor pad located at the first column of the third sensor pattern sub-group 130 may be connected by the first signal wire a1, while the sensor pad located at the first column of the second sensor pattern sub-group 120 and the sensor pad located at the fourth column of the fourth sensor pattern sub-group 140 may be connected by the second signal wire b1.

Similarly, the sensor pad located at the second column of the first sensor pattern sub-group 110 and the sensor pad located at the second column of the third sensor pattern sub-group 130 may be connected by the first signal wire a2, while the sensor pad located at the second column of the second sensor pattern sub-group 120 and the sensor pad located at the first column of the fourth sensor pattern sub-group 140 may be connected by the second signal wire b2.

In other words, the sequence in which the sensor pads belonging to the first and third sensor pattern sub-groups 110 and 130 are connected is different from that in which the sensor pads belonging to the second and fourth sensor pattern sub-groups 120 and 140 are connected.

Further, a way in which one of the sensor pads belonging to one of the sensor pattern sub-groups is connected to one of the sensor pads belonging to one of the other sensor pattern sub-groups may be variously realized.

Each sensor pad is connected to one of the sensor pads included in one of the other sensor pattern sub-groups, but not to the other sensor pads included in the same sensor pattern sub-group.

For example, the sensor pad located at the first column of the second sensor m pattern sub-group 120 may be connected to the sensor pad located at one of the first to fourth columns of the fourth sensor pattern sub-group 140. However, the sensor pad located at the first column of the second sensor pattern sub-group 120 is not connected to the other sensor pads located at the two to fourth columns of the second sensor pattern sub-group 120.

Further, the first signal wires a1, a2, a3, and a4 neither cross nor overlap with the second signal wires b1, b2, b3, and b4.

Here, the sensor pads included in the sensor pattern group 100 may be connected in various ways and positions by the first and second signal wires.

Further, the first signal wires a1, a2, a3, and a4 and the second signal wires b1, b2, b3, and b4 may be formed of the same material as the sensor pads 200. For example, if the sensor pads 200 are formed of a transparent conductive material such as ITO, the first signal wires a1, a2, a3, and a4 and the second signal wires b1, b2, b3, and b4 may also be formed of a transparent conductive material.

A detection region 30 is a region for detecting a touch, and may include a combined area of the two sensor pads 200. For example, as shown in FIG. 3, the detection region 30 may include an area in which the sensor pad located at the first column of the first sensor pattern sub-group 110 and the sensor pad located at the first column of the second sensor pattern sub-group 120 are included.

The sensor pads 200 are connected to a touch detector (not shown) by the first signal wires a1, a2, a3, and a4 and the second signal wires b1, b2, b3, and b4 so as to be able to detect a touch when the touch occurs.

Further, the touch detector may detect a touch area using a variation in voltage between when the touch of the sensor pad 200 occurs and when the touch of the sensor pad 200 does not occur.

How to detect a touch when the touch to the detection region 30 occurs will be described.

First, as shown in FIG. 3, the sensor pad A′ located at the first column of the first sensor pattern sub-group 110 is connected to the sensor pad B′ located at the first column of the third sensor pattern sub-group 130. Further, the sensor pad a′ located at the first column of the second sensor pattern sub-group 120 is connected to the sensor pad b′ located at the fourth column of the fourth sensor pattern sub-group 140.

In a state in which the sensor pad A′ belonging to the first sensor pattern sub-group 110 is connected to the sensor pad B′ belonging to the third sensor pattern sub-group 130, when a touch of the detection region 30 including the sensor pad A′ and the sensor pad a′ occurs, a touch area is detected using a variation in voltage between when the touch of the sensor pad A′ does not occurs and when the touch of the sensor pad A′ occurs. However, since the sensor pad A′ and the sensor pad B′ are electrically connected, both the touch of the sensor pad A′ and the touch of the sensor pad B′ are detected. Thus, it is not easy to distinguish the touches from each other.

However, the voltage variation of the sensor pad A′ is obtained, and the voltage variation between when the touch to the sensor pad a′ included in the detection region 30 does not occur and when the touch to the sensor pad a′ occurs is obtained. Using these voltage variations, it is possible to find at which of the sensor pads the touch occurs.

As described above, since the sensor pad A′ and the sensor pad B′ are connected, and since the sensor pad a′ and the sensor pad b′ are connected, it is possible to find that the touches of the sensor pad A′ and the sensor pad a′ included in the detection region 30 occur based on the voltage variation of each sensor pad, and that no touches of the sensor pad B′ and the sensor pad b′ occur.

Although the part of the description of the sensor pattern group shown in FIG. 3 is omitted, since the sensor pattern group shown in FIG. 3 has a configuration similar to that shown in FIGS. 2A to 2C, the description of the sensor pattern group shown in FIGS. 2A to 2C may be applied to the sensor pattern group shown in FIG. 3.

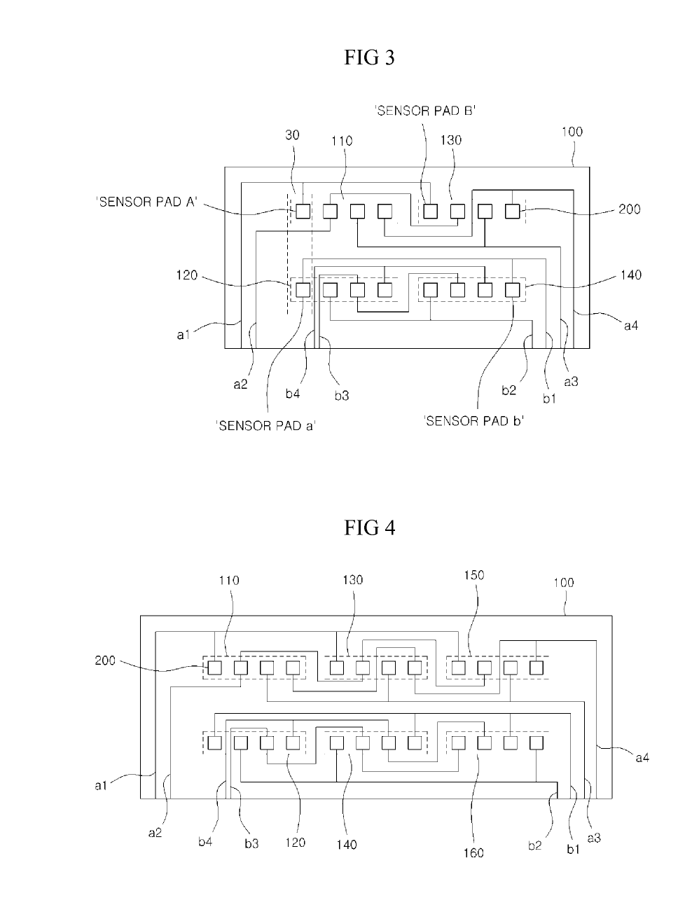

FIG. 4 illustrates a capacitive type touch detecting device according to yet another aspect.

As shown in FIG. 4, a sensor pattern group 100 of the capacitive type touch detecting device is an expansion of the sensor pattern group shown in FIG. 3, and has a connection pattern similar to that of the sensor pattern group shown in FIG. 3.

The sensor pattern group 100 of the capacitive type touch detecting device may include a first sensor pattern sub-group 110, a second sensor pattern sub-group 120, a third sensor pattern sub-group 130, a fourth sensor pattern sub-group 140, a fifth sensor pattern sub-group 150, and a sixth sensor pattern sub-group 160. That is, in the sensor pattern group 100 as shown in FIG. 4, the six sensor pattern sub-groups 110, 120, 130, 140, 150, and 160 may each include four sensor pads 200.

Here, the sensor pads belonging to the first, third, and fifth sensor pattern sub-groups 110, 130, and 150 may be electrically connected, and the sensor pads belonging to the second, fourth, and sixth sensor pattern sub-groups 120, 140, and 160 may be electrically connected.

Further, a sequence in which the sensor pads belonging to the first, third, and fifth sensor pattern sub-groups 110, 130, and 150 are connected may be different from that in which the sensor pads belonging to the second, fourth, and sixth sensor pattern sub-groups 120, 140, and 160 are connected.

In addition, the sensor pads 200 connected between the first, third, and fifth sensor pattern sub-groups 110, 130, and 150 may be connected by first signal wires a1, a2, a3, and a4, and the sensor pads 200 connected between the second, fourth, and sixth sensor pattern sub-groups 120, 140, and 160 may be connected by second signal wires b1, b2, b3, and b4.

In this way, the sensor pads included in the first and third sensor pattern sub-groups 110 and 130 of the sensor pattern group shown in FIG. 3 are connected, and the sensor pads located at the fifth sensor pattern sub-group 150 are additionally connected thereto. Further, the sensor pads included in the second and fourth sensor pattern sub-groups 120 and 140 of the sensor pattern group shown in FIG. 3 are connected, and the sensor pads located at the sixth sensor pattern sub-group 160 are additionally connected thereto.

For example, the sensor pad located at a first column of the first sensor pattern sub-group 110 may be connected to the sensor pads located at first columns of the third and fifth sensor pattern sub-groups 130 and 150 by the first signal wire a1. The sensor pad located at a second column of the first sensor pattern sub-group 110 may be connected to the sensor pads located at second columns of the third and fifth sensor pattern sub-groups 130 and 150 by the first signal wire a2.

Further, the sensor pad located at a first column of the second sensor pattern sub-group 120 may be connected to the sensor pad located at a fourth column of the fourth sensor pattern sub-group 140 and the sensor pad located at a third column of the sixth sensor pattern sub-group 160 by the second signal wire b1. The sensor pad located at a second column of the second sensor pattern sub-group 120 may be connected to the sensor pad located at a first column of the fourth sensor pattern sub-group 140 and the sensor pad located at a fourth column of the sixth sensor pattern sub-group 160 by the second signal wire b2.

Similarly, the sensor pad located at a third column of the second sensor pattern sub-group 120 may be connected to the sensor pad located at a second column of the fourth sensor pattern sub-group 140 and the sensor pad located at a first column of the sixth sensor pattern sub-group 160 by the second signal wire b3. The sensor pad located at a fourth column of the second sensor pattern sub-group 120 may be connected to the sensor pad located at a third column of the fourth sensor pattern sub-group 140 and the sensor pad located at a second column of the sixth sensor pattern sub-group 160 by the second signal wire b4.

In this way, although the part of the description of the sensor pattern group shown in FIG. 4 is omitted, since the sensor pattern group shown in FIG. 4 has a configuration similar to that shown in FIG. 3, the description of the sensor pattern group shown in FIG. 3 may be applied to the sensor pattern group shown in FIG. 4.

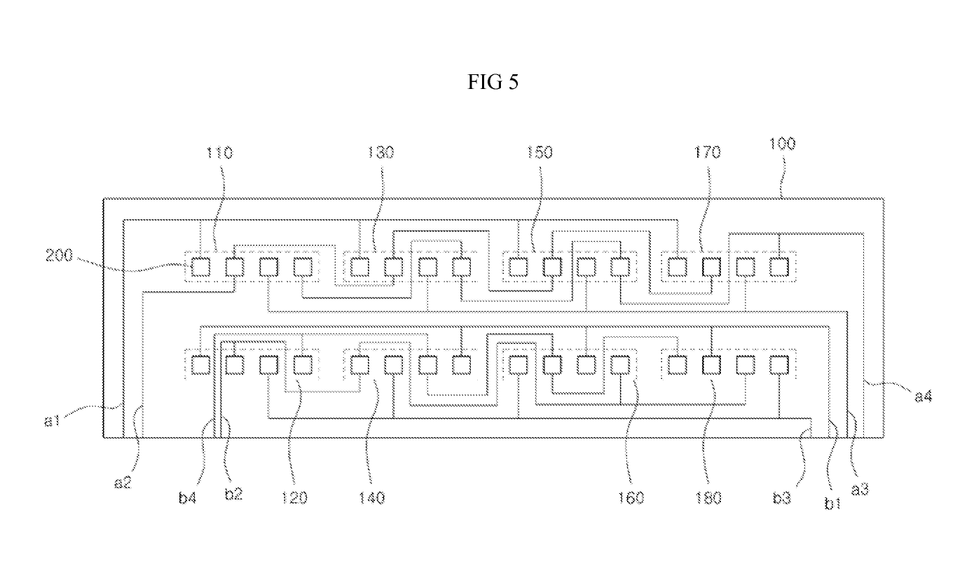

FIG. 5 illustrates a capacitive type touch detecting device according to yet another aspect.

As shown in FIG. 5, a sensor pattern group of the capacitive type touch detecting device may include sensor pads 200 disposed on the same plane.

The sensor pattern group of the capacitive type touch detecting device may include a first sensor pattern sub-group 110, a second sensor pattern sub-group 120, a third sensor pattern sub-group 130, a fourth sensor pattern sub-group 140, a fifth sensor pattern sub-group 150, a sixth sensor pattern sub-group 160, a seventh sensor pattern sub-group 170, and an eighth sensor pattern sub-group 180. That is, as shown in FIG. 5, the sensor pattern group 100 may include the eight sensor pattern sub-groups 110, 120, 130, 140, 150, 160, 170, and 180, each of which includes four sensor pads 200.

As shown in FIG. 5, like the sensor pattern group shown in FIG. 3 or 4, the sensor pattern group 100 of the capacitive type touch detecting device is configured so that sensor pads included in the sensor pattern sub-groups may be connected to one another.

The sensor pads 200 included in the first, third, fifth, and seventh sensor pattern sub-groups 110, 130, 150, and 170 may be electrically connected by first signal wires a1, a2, a3, and a4.

For example, the sensor pad located at a first column of the first sensor pattern sub-group 110 may be connected to the sensor pads located at first columns of the third, fifth, and seventh sensor pattern sub-groups 130, 150, and 170 by the first signal wire a1.

The sensor pads 200 included in the second, fourth, sixth, and eighth sensor pattern sub-groups 120, 140, 160, and 180 may be electrically connected by second signal wires b1, b2, b3, and b4.

For example, the sensor pad located at a first column of the second sensor pattern sub-group 120 may be connected to the sensor pad located at a fourth column of the fourth sensor pattern sub-group 140, the sensor pad located at a third column of the sixth sensor pattern sub-group 160, and the sensor pad located at a second column of the eighth sensor pattern sub-group 180 by the second signal wire b1. Further, the sensor pad located at a second column of the second sensor pattern sub-group 120 may be connected to the sensor pad located at a first column of the fourth sensor pattern sub-group 140, the sensor pad located at a fourth column of the sixth sensor pattern sub-group 160, and the sensor pad located at a third column of the eighth sensor pattern sub-group 180 by the second signal wire b2.

In summary, the sensor pads belonging to the first, third, fifth, and seventh sensor pattern sub-groups 110, 130, 150, and 170 may be electrically connected, and the sensor pads belonging to the second, fourth, sixth, and eighth sensor pattern sub-groups 120, 140, 160, and 180 may be electrically connected.

Further, a sequence in which the sensor pads belonging to the first, third, fifth, and seventh sensor pattern sub-groups 110, 130, 150, and 170 are connected may be different from that in which the sensor pads belonging to the second, fourth, sixth, and eighth sensor pattern sub-groups 120, 140, 160, and 180 are connected.

In this way, although the part of the description of the sensor pattern group shown in FIG. 5 is omitted, since the sensor pattern group shown in FIG. 5 has a configuration similar to that shown in FIG. 3 or 4, the description of the sensor pattern group shown in FIG. 3 or 4 may be applied to the sensor pattern group shown in FIG. 5.

In the sensor pattern groups shown in FIGS. 3 to 5, the sensor pads of the first, third, fifth and seventh sensor pattern sub-groups 110, 130, 150 and 170 are configured in such a way that the sensor pads located at the same columns are electrically connected, and the sensor pads of the second, fourth, sixth and eighth sensor pattern sub-groups 120, 140, 160 and 180 are configured in such a way that the sensor pads located at the same columns are electrically connected. The connection pattern is not limited to this configuration, but the sensor pads located at different columns may be electrically connected.

The sensor pattern groups of the capacitive type touch detecting devices shown in FIGS. 2A to 5 may be modified into a configuration similar to that in which the sensor pattern group is rotated 90 degrees, and may be realized in such a way that one or more sensor pattern sub-groups are disposed in a row or column direction.

That is, the sensor pattern groups of the capacitive type touch detecting devices shown in FIGS. 2A to 5 may be realized in such a way that the columns and the rows are switched.

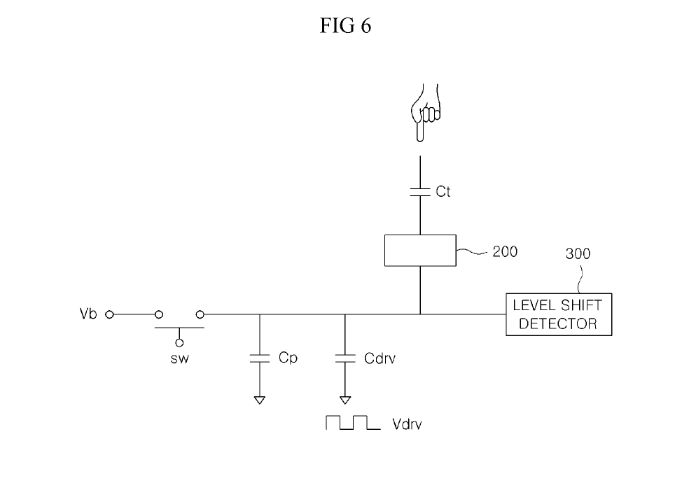

FIG. 6 shows a configuration of a capacitive type touch detecting device according to the aspect.

Referring to FIG. 6, a capacitive type touch detecting device according to the aspect may include a sensor pad 200, touch capacitance Ct, parasitic capacitance Cp, drive capacitance Cdrv, a charging unit SW, and a level shift detector 300.

First, a touch detecting operation of the touch detecting device will be described.

The sensor pad 200 is an electrode patterned on a substrate in order to detect touch input, and touch capacitance Ct is formed between the sensor pad 200 and a touch input tool such as a finger or a conductor. The sensor pad 200 may be formed of a transparent conductor. For example, the sensor pad 200 may be formed of a transparent material such as ITO, ATO, CNTs, or IZO. Alternatively, the sensor pad 200 may be formed of a metal.

The sensor pad 200 may output a signal according to a touched state of a touch input tool in response to an alternating current (AC) voltage Vdrv alternating at predetermined frequencies. For example, the sensor pad 200 may output different level shift values according to whether or not a touch occurs in response to an AC voltage Vdrv.

The charging unit SW is connected to an output terminal of the sensor pad 200, and supplies a charging signal Vb. The charging unit SW may be a three-terminal switching device performing a switching operation according to a control signal supplied to an on/off control terminal, or a linear device such as an operational amplifier (OP-AMP) supplying a signal according to a control signal. The output terminal of the charging unit SW is connected to capacitors having touch capacitance Ct, parasitic capacitance Cp, and drive capacitance Cdrv acting on the sensor pad 200. In a state in which the charging unit SW is turned on, the charging signal Vb is applied to an input terminal of the charging unit SW, and the capacitors having Ct, Cdrv, and Cp are charged. Then, when the charging unit SW is turned off, electric charges charged into the Ct and Cdrv are isolated in a charged state as long as they are not discharged separately. In this case, to stably isolate the charged electric charges, an input terminal of the level shift detector 300 to be described below may have high impedance.

The electric charges charged into the sensor pad by turning on the charging unit SW are isolated when the charging unit SW is turned off. This isolated state refers to a floating state. The electric charges that are charged by the charging signal and are isolated between the charging unit SW and the level shift detector 300 are subjected to a variation in level of voltage by an AC signal applied from the outside. The voltage level varies according to whether or not a touch occurs. A difference between the level prior to the touch and the level after the touch refers to a level shift.

The touch detecting device may further include an AC voltage generating unit (not shown).

The AC voltage generating unit applies the AC voltage Vdrv alternating at predetermined frequencies to the output terminal of the sensor pad 200 via the drive capacitance Cdrv, thereby changing a potential at the sensor pad 200. The AC voltage generating unit may generate a clock signal having the same duty ratio or an AC voltage having a different duty ratio.

A common electrode (not shown) serves as an electrode to which a common voltage is applied within a display device, and is shared within the display device. For example, a liquid crystal display (LCD) that is one of the display devices requires a common voltage to drive liquid crystals. Medium and small LCDs use an AC voltage Vdrv alternating at predetermined frequencies as the common voltage in order to reduce consumption of current. Large LCDs use a direct current (DC) voltage as the common voltage.

If common electrode voltage Vcom generated from the display device is used as the AC voltage, common electrode capacitance Cvcom serves as the drive capacitance Cdrv. In this case, the drive capacitance Cdrv may be temporarily removed.

Herein, the case in which the common electrode voltage is used as the AC voltage will not be separately described below. The same principle is also applied to this case, and falls within the scope of the appended claims.

The level shift detector 300 detects a level shift generated in a floating state by the AC voltage Vdrv. That is, the potential of the sensor pad is raised or lowered by the applied AC voltage Vdrv, and a variation of the voltage level caused by the touch has a lower value than that caused by no touch.

Thus, the level shift detector 300 detects the level shift by comparing the voltage levels before and after the touch. The level shift detector 300 may be configured of a combination of various devices or circuits.

For example, the level shift detector 300 may be configured of a combination of at least one of an amplifier amplifying the signal of the output terminal of the sensor pad 200, an analogue-to-digital converter (ADC), a voltage-to-frequency converter (VFC), a flip-flop, a latch, a buffer, a transistor (TR), a thin film transistor (TFT), and a comparator.

The touch detector (not shown) may detect a touch area using the level shift detected by the level shift detector 300. Here, the level shift detector 300 may be included in the touch detector or configured apart from the touch detector.

The level shift detector 300 may detect the level shift with respect to the identification pads (not shown).

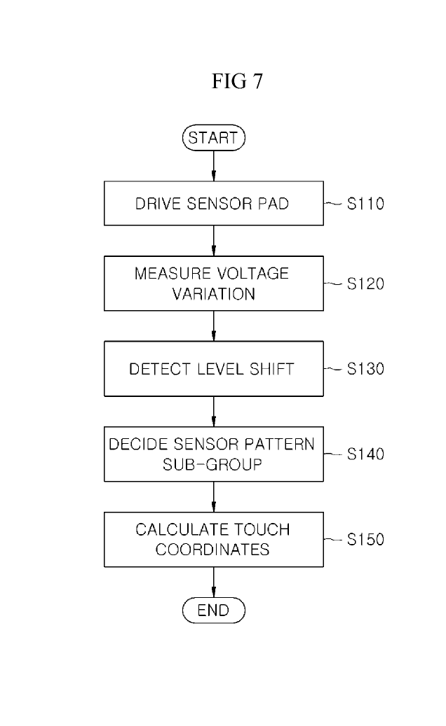

FIG. 7 is a flow chart showing a touch detecting method according to the aspect.

Referring to FIG. 7, in step S110, the touch detecting device drives the sensor pad 200. To be specific, a charging signal Vb is applied to the output terminal of the sensor pad 200, and the capacitors such as Cdrv connected to the sensor pad 200 are charged and floated.

Then, an AC voltage Vdrv is applied to the output terminal of the sensor pad 200. In step S120, the touch detecting device measures a voltage variation. The touch detecting device may measure a voltage variation between when a touch of the sensor pad 200 does not occur and when the touch of the sensor pad 200 occurs.

In step S130, the touch detecting device detects a level shift using the measured voltage variation. In this case, to detect the level shift, the touch detecting device may have a combination of various elements or circuits.

In step S140, the touch detecting device decides sensor pattern sub-groups. That is, the touch detecting device decides the sensor pattern sub-group(s) where the touch is detected. Here, the touch detecting device may decide which sensor pattern sub-group is touched using the detected level shift.

As described above, since the sensor pads of the sensor pattern sub-groups located at the same row are electrically connected, when a level shift value is generated from a specified sensor pad, it is possible to detect that the touch occurs, but it is impossible to determine sensor pattern sub-groups to which the sensor pads belong. However, the sensor pads of the sensor pattern sub-group located at an adjacent row are electrically connected in a sequence different from that in which the sensor pads of the sensor pattern sub-groups located at the same row are electrically connected. Thus, only a pattern that is preset when the sensor pads of the sensor pattern sub-groups located at two or more rows are touched (i.e., a pattern in which the sensor pads connected in each column in different sequences are touched in rows at the same time) is recognized to be actually touched, and thus the sensor pattern sub-groups to which the actually touched sensor pads belong may be decided.

When the sensor pattern sub-groups to which the sensor pads belong are decided, positions of the actually touched sensor pads are decided.

In step S150, the touch detecting device calculates touch coordinates. The touch detecting device may calculate the touch coordinates using a touch area calculated from the sensor pads belonging to the decided sensor pattern sub-groups.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents. For example, the components described in a combined type may be implemented in a distributed type. Similarly, the components described in a distributed type may be implemented in a combined type.

What is claimed is:

1. A capacitive type touch detecting device, comprising:
a first sensor pattern sub-group comprising first sensor pads disposed in a first axis direction;
a second sensor pattern sub-group adjacent to the first sensor pattern sub-group in a second axis direction, the second sensor pattern sub-group comprising second sensor pads disposed in the first axis direction;
a third sensor pattern sub-group adjacent to the first sensor pattern sub-group in the first axis direction, the third sensor pattern sub-group comprising third sensor pads disposed in the first axis direction, the third sensor pads electrically connected to the first sensor pads in a first sequence; and
a fourth sensor pattern sub-group adjacent to the second sensor pattern sub-group in the first axis direction, the fourth sensor pattern sub-group comprising fourth sensor pads disposed in the first axis direction, the fourth sensor pads electrically connected to the second sensor pads in a second sequence, the second sequence being different from the first sequence.

2. The capacitive type touch detecting device of claim 1, wherein the first, second, third, and fourth sensor pads are formed of the same material;
the first and third sensor pads are electrically connected by first signal wires, and the second and fourth sensor pads are electrically connected by second signal wires; and
the first and second wires are formed of the same material as the first, second, third and fourth sensor pads.

3. The capacitive type touch detecting device of claim 2, wherein the first signal wires connect the first and third sensor pads within a display region of the touch detecting device, and the second signal wires connect the second and fourth sensor pads within the display region of the touch detecting device.

4. The capacitive type touch detecting device of claim 2, wherein the first and second signal wires are disposed on the same plane without crossing one another.

5. The capacitive type touch detecting device of claim 2, wherein the first, second, third, and fourth sensor pads are formed of a transparent conductive material.

6. The capacitive type touch detecting device of claim 1, further comprising a touch detector that detects a touch based on a variation in voltage between when the touch of at least one sensor pad occurs and when the touch of the at least one sensor pad does not occur.

7. The capacitive type touch detecting device of claim 6, wherein the touch detector compares a pattern in which the voltage variation when the touch occurs at a plurality of sensor pads is generated with a preset pattern, and decides to which of the first to fourth sensor pattern sub-groups the sensor pads that are touched belong.

8. The capacitive type touch detecting device of claim 1, wherein a capacitive type touch detecting device is formed in a single layer.
